(19) United States
(12) Patent Application Publication
(10) Pub. No.: US 2026/0121021 A1
(43) Pub. Date: Apr. 30, 2026

(54) SECONDARY BATTERY AND PREPARATION METHOD THEREOF, POSITIVE ELECTRODE PLATE, NEGATIVE ELECTRODE PLATE AND ELECTRICALLY-POWERED DEVICE

(71) Applicant: BatteroTech Corporation Limited, Shanghai (CN)

(72) Inventors: Yuqian FANG, Shanghai (CN); Haining HUANG, Shanghai (CN)

(21) Appl. No.: 19/433,664

(22) Filed: Dec. 26, 2025

Related U.S. Application Data
(63) Continuation of application No. PCT/CN2024/111950, filed on Aug. 14, 2024.

(30) Foreign Application Priority Data
Apr. 17, 2024 (CN) 202410458717.4

(51) Int. Cl. H01M 4/136; H01M 4/02; H01M 4/133; H01M 4/525; H01M 4/58; H01M 4/583; H01M 4/66; H01M 50/417; H01M 50/451

(52) U.S. Cl. CPC H01M 4/136; H01M 4/133; H01M 4/525; H01M 4/5825; H01M 4/583; H01M 4/661; H01M 50/417; H01M 50/451; H01M 2004/021; H01M 2004/027; H01M 2004/028

(57) ABSTRACT

The present disclosure provides a secondary battery and a preparation method thereof, a positive electrode plate, a negative electrode plate and an electrically-powered device. A positive electrode active material includes a lithium iron phosphate (LFP) positive electrode material, Li₂NiO₂ and Li₅FeO₄. By adjusting a mixing ratio and limiting the mixing ratio, a specific capacity of active materials and an electrolyte filling coefficient to satisfy a specific relationship, the specific capacity and cycle performance of LFP batteries can be significantly improved, thereby making the lithium-ion batteries simultaneously exhibit superior energy density, cycle performance and safety.

### CROSS-REFERENCE TO RELATED APPLICATIONS

This application is a continuation of International Patent Application No. PCT/CN2024/111950, filed on Aug. 14, 2024, which claims the benefit of priority from Chinese Patent Application No. 2024104587174, filed on Apr. 17, 2024 and titled “Secondary battery and preparation method thereof, positive electrode plate, negative electrode plate and electrically-powered device”. The content of the aforementioned application, including any intervening amendments thereto, is incorporated herein by reference in its entirety.

### TECHNICAL FIELD

This application relates to lithium (Li)-ion batteries, and more particularly to a secondary battery and a preparation method thereof, a positive electrode plate, a negative electrode plate and an electrically-powered device.

### BACKGROUND

The development of new energy vehicles has been seriously restricted by the range. Currently, the power batteries are predominated by ternary batteries and lithium iron phosphate (LFP) batteries. Ternary batteries have a high energy density, but a lower economic efficiency and a poorer safety. LFP batteries have a lower energy density, but exhibit a lower manufacturing cost, higher safety and superior cycle life. Therefore, enhancing the energy density and the cycle life of LFP batteries has been widely considered as a direct and feasible approach to overcome the range limitation of new energy vehicles.

With the advancement of battery design and manufacturing technologies, the utilization of internal space in the battery casing has been optimized to its limit, making it extremely difficult to further improve the energy density through spatial optimization. Currently, the main approach to enhance the energy density and cycle performance is performed by optimizing the positive electrode active material. The formation of solid electrolyte interface (SEI) on the negative electrode of lithium-ion batteries will consume active lithium, resulting in attenuated initial capacity and shortened service life. To address this problem, a small amount of lithium sources can be introduced by lithium replenishment technologies (also named lithium supplementing) before charge-discharge cycles, which not only improves the initial charge-discharge efficiency but also compensates for the lithium loss during cycling. At present, the lithium replenishment is performed mainly by negative electrode lithium supplementing and positive electrode lithium supplementing.

The development of the negative electrode lithium supplementing has a relatively long history, mainly including lithium foil-based lithium supplementing, lithium powder-based lithium supplementing, and chemical lithium supplementing. Regarding the lithium foil-based lithium supplementing, a self-discharge mechanism driven by potential difference is utilized, in which in the existence of electrolyte, when the negative electrode material comes into contact with the lithium metal foil, electrons spontaneously move towards the negative electrode, accompanied by the intercalation of Li into the negative electrode. Lithium powder can be directly applied to a surface of the negative electrode plate or introduced during the negative electrode slurry mixing process. Although the negative electrode lithium supplementing offers a relatively high lithium supplementing capacity, it imposes extremely stringent requirements for processing equipment and environment and poses serious safety risks due to the high chemical reactivity of active lithium.

Positive electrode lithium supplementing usually adopts electrochemical methods by adding positive electrode lithium supplementing additives into lithium-ion batteries. During the charging process, these additives can release active lithium to compensate for the consumption caused by the formation of SEI on the negative electrode, while prolonging the cycle life of batteries. The positive electrode lithium supplementing additives have a high safety, but the single-component additives still have several limitations. For example, Li₅FeO₄ exhibits a high capacity, with a theoretical specific capacity up to 867 mAh/g, but it suffers from poor stability in an air environment, and will generate oxygen during the delithiation process. Conversely, Li₂NiO₂ has an excellent processing performance and does not produce gas during the delithiation reaction, but its high impedance will adversely affect the battery's rate performance and cycle performance. Therefore, the current positive electrode lithium supplementing technologies still cannot achieve the simultaneous enhancement of the energy density and cycle life of LFP batteries.

In view of this, the present application is herein proposed.

### SUMMARY

An object of the disclosure is to provide a secondary battery and a preparation method thereof, a positive electrode plate, a negative electrode plate and an electrically-powered device, so as to achieve the simultaneous enhancement of cycle life and energy density of lithium iron phosphate (LFP) batteries.

In order to achieve the above object, the following technical solutions are adopted herein.

In a first aspect, the present disclosure provides a secondary battery, comprising:
a positive electrode plate;
a negative electrode plate; and
a separator;
wherein the positive electrode plate comprises a positive electrode active material and a positive electrode current collector; the negative electrode plate comprises a negative electrode active material and a negative electrode current collector; and the positive electrode active material comprises a LFP positive electrode material, a first lithium supplementing additive and a second lithium supplementing additive; the first lithium supplementing additive comprises Li₂NiO₂ and the second lithium supplementing additive comprises Li₅FeO₄;
wherein the secondary battery has a first performance parameter α and a second performance parameter β respectively satisfying the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

wherein the first performance parameter α satisfies 1.0≤α≤1.13; and the second performance parameter β satisfies 6<β<10;
A₁ represents a weight percentage of the LFP positive electrode material in the positive electrode active material;
A₂ represents a weight percentage of the first lithium supplementing additive in the positive electrode material;
A₃ represents a weight percentage of the second lithium supplementing additive in the positive electrode material;
M₁ represents an initial charge specific capacity of the LFP positive electrode material, expressed in a unit of mAh/g;
M₂ represents an initial charge specific capacity of the first lithium supplementing additive, expressed in a unit of mAh/g;
M₃ represents an initial charge specific capacity of the second lithium supplementing additive, expressed in a unit of mAh/g;
M₄ represents an initial charge specific capacity of the negative electrode active material, expressed in a unit of mAh/g;
X represents a coating amount of the positive electrode active material on the positive electrode current collector, expressed in a unit of mg/cm²;
Y represents a coating amount of the negative electrode active material on the negative electrode current collector, expressed in a unit of mg/cm²; and
C represents an electrolyte filling coefficient, expressed in a unit of g/Ah.

The secondary battery satisfies at least one of the following conditions:

$${A}_{1} + {A}_{2} + {A}_{3} = 1 , 80 \% \leq {A}_{1} \leq 99 \% , 0 < {A}_{2} \leq 15 \% , and 0 < {A}_{3} \leq 15 \% ;$$

X is 17-32 mg/cm²;
in response to a case that a discharge voltage range of the secondary battery is 2.0-4.4 V, M₁ is 150-170 mAh/g, M₂ is 400-500 mAh/g, and M₃ is 650-750 mAh/g;
M₄ is 350-400 mAh/g;
the negative electrode active material is graphite, and Y is 5-20 mg/cm²; and
C satisfies C≤3.6 g/Ah.

In some embodiments, a material coated on the positive electrode current collector in the preparation of the positive electrode plate is a total positive electrode composite, and a weight percentage of the positive electrode active material in the total positive electrode composite is 92-99%.

In some embodiments, a material coated on the negative electrode current collector in the preparation of the negative electrode plate is a total negative electrode composite, and a weight percentage of the negative electrode active material in the total negative electrode composite is 85-99%.

In some embodiments, the negative electrode current collector is selected from the group consisting of copper foil, composite copper foil and a combination thereof; and a thickness of the negative electrode current collector is 1-20 μm.

In some embodiments, the separator comprises a substrate and a coating attached to the substrate; a thickness of the substrate is 5-20 μm; and a thickness of the coating is 1-6 μm.

In some embodiments, the substrate is made of polypropylene (PP), polyethylene (PE) or a combination thereof; and the coating is made of a ceramic material.

In some embodiments, the LFP positive electrode material is doped with an element selected from the group consisting of Ti, Al, Mg, V, Ni, Mn and a combination thereof; and a content of the element doped in the LFP positive electrode material is less than 5,000 ppm.

In some embodiments, the first lithium supplementing additive is doped with an element selected from the group consisting of Ti, Al, Co, Mn and a combination thereof.

In some embodiments, a content of the element doped in the first lithium supplementing additive is less than 5,000 ppm.

In some embodiments, the second lithium supplementing additive is doped with an element selected from the group consisting of Mn, Cu, Mo, Al, Ti, Mg, Zr, Zn and a combination thereof.

In some embodiments, a content of the element doped in the second lithium supplementing additive is less than 5,000 ppm.

In some embodiments, a surface of the second lithium supplementing additive is coated with a carbon layer; and a weight percentage of the carbon in the second lithium supplementing additive is 0.2-5.0%.

In a second aspect, the present disclosure provides a method of preparing the above secondary battery, comprising:

in the preparation of the secondary battery, defining a first performance parameter α and a second performance parameter β, and setting the first performance parameter α and the second performance parameter β to meet corresponding requirements.

In a third aspect, the present disclosure provides a positive electrode plate, comprising:
a positive electrode active material; and
a positive electrode current collector;
wherein the positive electrode active material comprises the a lithium iron phosphate (LFP) positive electrode material, a first lithium supplementing additive and a second lithium supplementing additive; the first lithium supplementing additive is Li₂NiO₂, and the second lithium supplementing additive is Li₅FeO₄; the positive electrode plate is configured to prepare a secondary battery comprising the positive electrode plate, a negative electrode plate and a separator; and the negative electrode plate comprises a negative electrode active material and a negative electrode current collector;
the secondary battery has a first performance parameter α and a second performance parameter β respectively satisfying the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

wherein the first performance parameter α satisfies 1.0≤α≤1.13; and the second performance parameter β satisfies 6<<10;
A₁ represents a weight percentage of the LFP positive electrode material in the positive electrode active material;
A₂ represents a weight percentage of the first lithium supplementing additive in the positive electrode material;
A₃ represents a weight percentage of the second lithium supplementing additive in the positive electrode material;
M₁ represents an initial charge specific capacity of the LFP positive electrode material, expressed in a unit of mAh/g;
M₂ represents an initial charging charge specific of the first lithium supplementing additive, expressed in a unit of mAh/g;
M₃ represents an initial charging charge specific of the second lithium supplementing additive, expressed in a unit of mAh/g;
M₄ represents an initial charging charge specific of the negative electrode active material, expressed in a unit of mAh/g;
X represents a coating amount of the positive electrode active material on the positive electrode current collector, expressed in a unit of mg/cm²;
Y represents a coating amount of the negative electrode active material on the negative electrode current collector, expressed in a unit of mg/cm²;
C represents an electrolyte filling coefficient, expressed in a unit of g/Ah;
the secondary battery satisfies at least one of the following conditions:

$${A}_{1} + {A}_{2} + {A}_{3} = 1 , 80 \% \leq {A}_{1} \leq 99 \% , 0 < {A}_{2} \leq 15 \% , and 0 < {A}_{3} \leq 15 \% ;$$

X is 17-32 mg/cm²;
in response to a case that a discharge voltage range of the secondary battery is 2.0-4.4 V, M₁ is 150-170 mAh/g, M₂ is 400-500 mAh/g, and M₃ is 650-750 mAh/g; M₄ is 350-400 mAh/g;
the negative electrode active material is graphite, and Y is 5-20 mg/cm²; and
C satisfies C≤3.6 g/Ah.

In a fourth aspect, the present disclosure provides a negative electrode plate, comprising:
a negative electrode active material; and
a negative electrode current collector;
wherein the negative electrode plate is configured to prepare a secondary battery comprising a positive electrode plate, the negative electrode plate and a separator; the positive electrode plate comprises a positive electrode active material and a positive electrode current collector; the positive electrode active material comprises a lithium iron phosphate (LFP) positive electrode material, a first lithium supplementing additive and a second lithium supplementing additive, wherein the first lithium supplementing additive is Li₂NiO₂, and the second lithium supplementing additive is Li₅FeO₄.
the secondary battery has a first performance parameter α and a second performance parameter β respectively satisfying the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

wherein the first performance parameter α satisfies 1.0≤α≤1.13; and the second performance parameter β satisfies 6<3<10;
A₁ represents a weight percentage of the LFP positive electrode material in the positive electrode active material;
A₂ represents a weight percentage of the first lithium supplementing additive in the positive electrode active material;
A₃ represents a weight percentage of the second lithium supplementing additive in the positive electrode active material;
M₁ represents an initial charge specific capacity of the LFP positive electrode material, expressed in a unit of mAh/g;
M₂ represents an initial charge specific capacity of the first lithium supplementing additive, expressed in a unit of mAh/g;
M₃ represents an initial charge specific capacity of the second lithium supplementing additive, expressed in a unit of mAh/g;
M₄ represents an initial charge specific capacity of the negative electrode active material, expressed in a unit of mAh/g;
X represents a coating amount of the positive electrode active material on the positive electrode current collector, expressed in a unit of mg/cm²;
Y represents a coating amount of the negative electrode active material on the negative electrode current collector, expressed in a unit of mg/cm²;
C represents an electrolyte filling coefficient, expressed in a unit of g/Ah;
the secondary battery satisfies at least one of the following conditions:

$${A}_{1} + {A}_{2} + {A}_{3} = 1 , 80 \% \leq {A}_{1} \leq 99 \% , 0 < {A}_{2} \leq 15 \% , and 0 < {A}_{3} \leq 15 \% ;$$

X is 17-32 mg/cm²;
in response to a case that a discharge voltage range of the secondary battery is 2.0-4.4 V, M₁ is 150-170 mAh/g, M₂ is 400-500 mAh/g, and M₃ is 650-750 mAh/g; M₄ is 350-400 mAh/g;
the negative electrode active material is graphite, and Y is 5-20 mg/cm²; and
C satisfies C≤3.6 g/Ah.

In a fifth aspect, the present disclosure provides an electrically-powered device, comprising:
the above secondary battery; or
a secondary battery prepared according to the above method.

The beneficial effects of the present disclosure are described below. A positive electrode active material includes a lithium iron phosphate (LFP) positive electrode material, Li₂NiO₂ and Li₅FeO₄. By adjusting a mixing ratio and limiting the mixing ratio, a specific capacity of active materials and an electrolyte filling coefficient to satisfy a specific relationship, the specific capacity and cycle performance of LFP batteries can be significantly improved, thereby making the lithium ion batteries simultaneously exhibit superior energy density, cycle performance and safety.

### DETAILED DESCRIPTION OF EMBODIMENTS

To make the objectives, technical solutions and advantages of the embodiments of the present disclosure clearer, the technical solutions in the embodiments of the present disclosure will be described clearly and completely below. Unless otherwise specified, the experiments in the following embodiments are performed under the conventional conditions or the conditions recommended by the manufacturer, and reagents or instruments are all commercially available.

The present disclosure provides a secondary battery, including a positive electrode plate, a negative electrode plate and a separator. According to parameters of the positive electrode plate, the negative electrode plate and the separator, a first performance parameter α and a second performance parameter β are defined. By adjusting formulas of the first performance parameter α and the second performance parameter β, the first performance parameter α and the second performance parameter α are configured to meet a specific value range, thereby making the lithium ion batteries simultaneously exhibit superior energy density and cycle performance.

In an embodiment, the positive electrode plate includes a positive electrode active material and a positive electrode current collector. The positive electrode active material is a main component of a positive electrode active coating formed on the positive electrode current collector. The negative electrode plate includes a negative electrode active material and a negative electrode current collector. The negative electrode active material is a main component of a negative electrode active coating formed on the negative electrode current collector.

In this case, the embodiments of the present disclosure provide a method of adjusting the first performance parameter α and the second performance parameter β regarding of lithium iron phosphate (LFP) batteries.

In an embodiment, the positive electrode active material includes a LFP positive electrode material, a first lithium supplementing additive and a second lithium supplementing additive. The first lithium supplementing additive is Li₂NiO₂, and the second lithium supplementing additive is Li₅FeO₄. By adding a double lithium supplementing material of Li₂NiO₂ and Li₅FeO₄, disadvantages of a single lithium supplementing material are compensated, thereby making the lithium-ion batteries simultaneously exhibit superior energy density and cycle performance.

In an embodiment, the first performance parameter α and the second performance parameter α respectively satisfy the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

where the first performance parameter α satisfies 1.0≤α≤1.13, and the second performance parameter β satisfies 6<β<10. By adjusting a and B, the applicant noted that the lithium-ion batteries simultaneously exhibited superior energy density and cycle performance within this range.

In an embodiment, the first performance parameter α can be 1.00, 1.02, 1.05, 1.08, 1.10 or 1.13; and the second performance parameter β can be 6.0, 7.0, 8.0, 9.0, or 10.0.

Individual parameters involved in expressions of the first performance parameter α and the second performance parameter β are defined as follows:
A₁ represents a weight percentage of the LFP positive electrode material in the positive electrode active material, which is substituted into the formula in the form of percentage, such as 90% (i.e., 0.9);
A₂ represents a weight percentage of the first lithium supplementing additive in the positive electrode active material, which is substituted into the formula in the form of percentage, such as 5% (i.e., 0.05); and
A₃ represents a weight percentage of the second lithium supplementing additive in the positive electrode active material, which is substituted into the formula in the form of percentage, such as 5% (i.e., 0.05).

In some embodiments, A₁+A₂+A₃=1, and on the premise of A₁+A₂+A₃=1, 80%<A₁≤99%, 0<A₂≤15% and 0<A₃<15%; preferably, 88%≤A₁<99%, 0<A₂≤10% and 0<A₃≤10%.

In some embodiments, A₁ can be 80%, 82%, 84%, 86%, 88%, 90%, 92%, 95%, 97% or 99%; A₂ can be 0.1%, 0.5%, 0.7%, 1.0%, 2.0%, 3.0%, 4.0%, 5.0%, 6.0%, 7.0%, 8.0%, 9.0%, 10.0%, 11.0%, 12.0%, 13.0%, 14.0% or 15.0%; A₃ can be 0.1%, 0.5%, 0.7%, 1.0%, 2.0%, 3.0%, 4.0%, 5.0%, 6.0%, 7.0%, 8.0%, 9.0%, 10.0%, 11.0%, 12.0%, 13.0%, 14.0% or 15.0%.
M₁ represents an initial charge specific capacity of the LFP positive electrode material, expressed in a unit of mAh/g; on the premise of a discharging voltage range of 2.0-4.4 V of the secondary battery, M₁ is relatively fixed, generally ranging from 150 mAh/g to 170 mAh/g, and preferably, M₁ is ranging from 158 mAh/g to 165 mAh/g, such as 150 mAh/g, 160 mAh/g and 170 mAh/g;
M₂ represents an initial charge specific capacity of the first lithium supplementing additive, expressed in a unit of mAh/g; on the premise of a discharging voltage range of 2.0-4.4 V of the secondary battery, M₂ is relatively fixed due to a fixed material, generally ranging from 400 mAh/g to 500 mAh/g, and preferably ranging from 400 mAh/g to 440 mAh/g, such as 400 mAh/g, 420 mAh/g, 430 mAh/g, 440 mAh/g, 450 mAh/g, 480 mAh/g and 500 mAh/g;
M₃ represents an initial charge specific capacity of the second lithium supplementing additive, expressed in a unit of mAh/g; on the premise of a discharging voltage range of 2.0-4.4 V of the secondary battery, M₃ is relatively fixed due to a fixed material, generally ranging from 650 mAh/g to 750 mAh/g, and preferably ranging from 690 mAh/g to 710 mAh/g, such as 650 mAh/g, 680 mAh/g, 700 mAh/g and 750 mAh/g;
M₄ represents an initial charge specific capacity of the negative electrode active material, expressed in a unit of mAh/g; M₄ of a different material varies slightly, and the initial charge specific capacity M₄ is ranging from 350 mAh/g to 400 mAh/g, preferably ranging from 370 mAh/g to 380 mAh/g; if the negative electrode active material is made of a graphite material, specifically artificial graphite, natural graphite, or a combination thereof, the initial charge specific capacity M₄ of the graphite material is 375 mAh/g; and
C represents an electrolyte filling coefficient, which is an exactly fixed constant, referring to a ratio of a filling volume of electrolyte and a preset discharging capacity in batteries; a calculation formula of C satisfies:

$$electrolyte filling coefficient = \frac{filling volume}{discharging capacity} g / Ah .$$

In some embodiments, C satisfies C≤3.6 g/Ah, preferably within a range of 2.9-3.5 g/Ah, such as 2.9 g/Ah, 3.0 g/Ah, 3.1 g/Ah, 3.2 g/Ah, 3.3 g/Ah, 3.4 g/Ah and 3.5 g/Ah.

X represents a coating amount of the positive electrode active material on the positive electrode current collector, expressed in a unit of mg/cm², referring to that X represents a content of the positive electrode active material (including the LFP positive electrode material, the first lithium supplementing additive and the second lithium supplementing additive) contained in each square centimeter of the positive electrode current collector. X can be 17 mg/cm², 20 mg/cm², 25 mg/cm², 30 mg/cm² or 32 mg/cm², within a range of 17-32 mg/cm².

In some embodiments, a material coated on the positive electrode current collector in the preparation of the positive electrode plate is a total positive electrode composite, and a weight percentage of the positive electrode active material in the total positive electrode composite is 92-99%, and other components are a conductive agent (such as conductive carbon black), a binder (such as polyvinylidene fluoride) and a dispersant (such as N-methylpyrrolidone), respectively. In other words, an area density of a single-side coating of the positive electrode active material X equals a multiplied by X_{total positive electrode composite}, where a is 92-99%.

In some embodiments, LiFePO₄ is a main component of the LFP positive electrode material. The LFP positive electrode material is doped with an element selected from the group consisting of Ti, Al, Mg, V, Ni, Mn and a combination thereof, and a content of the element doped in the LFP positive electrode material is less than 5,000 ppm.

In some embodiments, the first lithium supplementing additive is doped with an element selected from the group consisting of Ti, Al, Co, Mn and a combination thereof, and a content of the element doped in the first lithium supplementing additive has no limitation, and is less than 5,000 ppm.

In some embodiments, the second lithium supplementing additive is doped with an element selected from the group consisting of Mn, Cu, Mo, Al, Ti, Mg, Zr, Zn and a combination thereof. A surface of the second lithium supplementing additive is coated with a carbon layer, and a weight percentage of carbon in the second lithium supplementing additive is 0.2-5.0%. Preferably, the surface of the second lithium supplementing additive can be 0.2%, 0.5%, 1.0%, 2.0%, 3.0%, 4.0% or 5.0%.

Y represents a coating amount of the negative electrode active material on the negative electrode current collector, expressed in a unit of mg/cm², referring to that Y represents a content of the negative electrode active material (such as graphite) contained in each square centimeter of the negative electrode current collector. Y can be 5, 8, 10, 12, 15, 18 or 20 mg/cm², within a range of 5-20 mg/cm²; and preferably, within a range of 8-15 mg/cm².

In some embodiments, a material coated on the negative electrode current collector is a total negative electrode composite, and a weight percentage of the negative electrode active material in the total negative electrode composite is 85-99%, preferably, 92-99%, and other components include a conductive agent (such as conductive carbon black), a binder (such as polyvinylidene fluoride) and a dispersant (such as N-methylpyrrolidone). In other words, an area density of a single-sided coating of the negative electrode active material Y equals b multiplied by Y_{total negative electrode composite}, where b is 92-99%.

In some embodiments, the negative electrode current collector is selected from the group consisting of copper foil, composite copper foil and a combination thereof; and a thickness of the negative electrode current collector is 1-20 μm, preferably, 4-10 μm, such as 1 μm, 2 μm, 4 μm, 6 μm, 8 μm, 10 μm, 15 μm and 20 μm.

In some embodiments, the separator includes a substrate and a coating attached to the substrate. A thickness of the substrate is 5-20 μm (such as 5 μm, 10 μm, 15 μm and 20 μm), and a thickness of the coating is 1-6 μm (such as 1 μm, 2 μm, 4 μm and 6 μm). The substrate is made of polypropylene (PP), polyethylene (PE) or a combination thereof; and the coating is made of a ceramic material. There is no limitation on specific materials, mainly aluminium oxide, a binder or a combination thereof.

It should be noted that the first performance parameter α represents an excess ratio of the charge capacity of the negative electrode plate relative to that of the positive electrode plate. If value a is too low, there is a risk of lithium plating on the negative electrode plate during a charging process; if value a is too high, the coating amount on the negative electrode plate will be excessive. As a result, more active lithium will be consumed when the negative electrode plate forms the solid electrolyte interface (SEI), which is not conducive to a capacity performance of the positive electrode material and reduce the energy density of the battery.

It should be noted that there is no limitation on the number of cells in the secondary battery provided by the embodiments of this disclosure, and the cell can be in the form of a battery pack.

The present disclosure provides a method of preparing the secondary battery in the above embodiments, including in the preparation of the secondary battery, defining the first performance parameter α and the second performance parameter β, and setting the first performance parameter α and the second performance parameter β to meet corresponding requirements.

In some embodiments, during the preparing process, some parameters such as values of A₁, A₂, A₃, M₂, and M₃, an area density of the active material coating during the preparation of the positive electrode plate and the negative electrode plate, and an electrolyte filling coefficient are adjusted, respectively. By adjusting the above parameters and constructing the formulas of the first performance parameter α and the second performance parameter β, a and B can meet specific ranges. The applicant found that by adopting this method, the relationship between energy density and cycle life can be better balanced, effectively enhancing the energy density of the cells and maintaining cycles at a superior level.

In some embodiments, the present disclosure provides the positive electrode plate, including the positive electrode active material and the positive electrode current collector. The positive electrode active material includes the LFP positive electrode material, the first lithium supplementing additive and the second lithium supplementing additive. The first lithium supplementing additive is Li₂NiO₂, and the second lithium supplementing additive is Li₅FeO₄. The positive electrode plate is configured to prepare the secondary battery, including the positive electrode plate, the negative electrode plate and the separator. The negative electrode plate includes the negative electrode active material and the negative electrode current collector.

The secondary battery has the first performance parameter α and the second performance parameter β respectively satisfying the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

where the first performance parameter α satisfies 1.0≤α≤1.13; and the second performance parameter β satisfies 6<3<10;
A₁ represents a weight percentage of the LFP positive electrode material in the positive electrode active material;
A₂ represents a weight percentage of the first lithium supplementing additive in the positive electrode material;
A₃ represents a weight percentage of the second lithium supplementing additive in the positive electrode material;
M₁ represents an initial charge specific capacity of the LFP positive electrode material, expressed in a unit of mAh/g;
M₂ represents an initial charge specific capacity of the first lithium supplementing additive, expressed in a unit of mAh/g;
M₃ represents an initial charge specific capacity of the second lithium supplementing additive, expressed in a unit of mAh/g;
M₄ represents an initial charge specific capacity of the negative electrode active material, expressed in a unit of mAh/g;
X represents a coating amount of the positive electrode active material on the positive electrode current collector, expressed in a unit of mg/cm²;
Y represents a coating amount of the negative electrode active material on the negative electrode current collector, expressed in a unit of mg/cm²; and
C represents an electrolyte filling coefficient, expressed in a unit of g/Ah.

The value range of individual parameters can be referred to the aforementioned content of the description and will not be repeated herein.

The present disclosure provides the negative electrode plate, including the negative electrode active material and the negative electrode current collector. The negative electrode plate is configured to prepare the secondary battery, including the positive electrode plate, the negative electrode plate and the separator. The positive electrode plate includes the positive electrode active material and the positive electrode current collector. The positive electrode active material includes the LFP positive electrode material, the first lithium supplementing additive and the second lithium supplementing additive. The first lithium supplementing additive is Li₂NiO₂ and the second lithium supplementing additive is Li₅FeO₄.

The secondary battery has the first performance parameter α and the second performance parameter β respectively satisfying the following formulas:

$$α = \frac{{M}_{4} * Y}{( {M}_{1} * {A}_{1} + {M}_{2} * {A}_{2} + {M}_{3} * {A}_{3} ) * X} ; and$$

$$β = \frac{( {A}_{2} + {A}_{3} ) * 30 * 1000}{{M}_{2} + {M}_{3}} + 2 C ;$$

where the first performance parameter α satisfies 1.0≤α≤1.13; and the second performance parameter β satisfies 6<<10;
A₁ represents a weight percentage of the LFP positive electrode material in the positive electrode active material;
A₂ represents a weight percentage of the first lithium supplementing additive in the positive electrode active material;
A₃ represents a weight percentage of the second lithium supplementing additive in the positive electrode active material;
M₁ represents an initial charge specific capacity of the LFP positive electrode material, expressed in a unit of mAh/g;
M₂ represents an initial charge specific capacity of the first lithium supplementing additive, expressed in a unit of mAh/g;
M₃ represents an initial charge specific capacity of the second lithium supplementing additive, expressed in a unit of mAh/g;
M₄ represents an initial charge specific capacity of the negative electrode active material, expressed in a unit of mAh/g;
X represents a coating amount of the positive electrode active material on the positive electrode current collector, expressed in a unit of mg/cm²;
Y represents a coating amount of the negative electrode active material on the negative electrode current collector, expressed in a unit of mg/cm²; and
C represents an electrolyte filling coefficient, expressed in a unit of g/Ah.

The value range of individual parameters can be referred to the aforementioned content of the description and will not be repeated herein.

The embodiment of this disclosure provides an electrically-powered device, including the secondary battery and an electrical appliance. The secondary battery is used to supply power to the electrical appliance.

The features and performances of the present disclosure will be further detailly described in combination with the embodiments.

### Embodiment 1

The embodiment provided a method of preparing a secondary battery. During the preparation process, the formulas of the first performance parameter α and the second performance parameter β were constructed, such that a and B could meet the corresponding requirements.

### (1) Preparation of a Positive Electrode Plate

The positive electrode active component was LiFePO₄. The lithium supplementing additive was Li₂NiO₂, where the doped element was A₁, and the content of the doped element was 500 ppm. The lithium supplementing additive was Li₅FeO₄, where the doped elements were A₁ and Ti, and the total content of the doped elements was 8,000 ppm. M₁ was 160 mAh/g. M₂ was 420 mAh/g. M₃ was 700 mAh/g.

The positive electrode active material includes LiFePO₄, Li₂NiO₂ and Li₅FeO₄, with weight percentages controlled to at 95.5%, 0.5% and 4%, respectively.

The positive electrode active material, a conductive agent (conductive carbon black) and a binder (polyvinylidene fluoride) were mixed in a weight ratio of 97:1: 2 to obtain a mixture. The mixture was added with a dispersant (polyvinylpyrrolidone) to form a positive electrode slurry with a solid content of 57-61%. The positive electrode slurry was evenly coated on front and back sides of a positive electrode current collector and dried to form a coating, where a coating amount of the positive electrode active material on the positive electrode current collector was controlled to at 24.6 mg/cm². The current collector was compacted by rolling to obtain the positive electrode plate with a compaction density P.D of 2.55 g/cm³. The positive electrode current collector was an aluminum foil with a thickness of 13 μm.

### (2) Preparation of a Negative Electrode Plate

A negative electrode active material (artificial graphite), a conductive agent (conductive carbon black), a binder (styrene-butadiene rubber, SBR) and a dispersant (sodium carboxymethyl cellulose, CMC) were mixed in a weight ratio of 95:1: 2:2, and dispersed with deionized water to form a negative electrode slurry with a solid content of 48-53%. The negative electrode slurry was coated on front and back sides of a negative electrode current collector, and dried under heating to form a coated current collector, where a coating amount Y of the negative electrode active material on the negative electrode current collector was controlled to at 13.2 mg/cm². The coated current collector was compacted by rolling to obtain a negative electrode plate, where an initial charge specific capacity M₄ of the negative electrode active material was 375 mAh/g, and the negative electrode current collector was a copper foil with a thickness of 6 μm.

### (3) Preparation of a Separator

Front and back sides of a PE base film were respectively coated with a nano-alumina coating, and dried in a vacuum oven for solvent removal to obtain the separator, where a thickness of the PE base film was 7 μm, and a thickness of the coating was 3 μm.

### (4) Assembly

The positive electrode plate, the negative electrode plate and the separator obtained above were stacked in a Z shape with a sequence of “separator-negative electrode plate-separator-positive electrode plate”, ensuring that the positive electrode plate was completely at a middle of the negative electrode plate. The stacked structure was sequentially subjected to hot pressing, tab welding, packaging and baking, where a total water content in the positive electrode plate, the negative electrode plate and the separator after baking was controlled to at 250 ppm. Then the stacked structure was filled with an electrolyte to obtain the secondary battery, where an electrolyte filling coefficient C was controlled to at 3.5 g/Ah.

The embodiment also provided a secondary battery prepared according to the above method.

### Embodiments 2-5

The only difference between embodiments 2-5 and embodiment 1 lay in the different values of the parameters. Parameters with different values were all listed in Table 1.

### Comparative Examples 1-2

The only difference between comparative examples 1-2 and embodiment 1 lay in the different values of the parameters. Parameters with different values were all listed in Table 1.

TABLE 1
Parameter control of embodiments and comparative examples in the preparation
process and performances of the obtained secondary batteries

| | | | | | | | | | | | 1 C/1 C 45° C. | |
|---|---|---|---|---|---|---|---|---|---|---|---|---|
| | | | | | | | | | | | 3.5-3.65 V | |
| | | | | | | | | | | | 500-cycle | |
| | | | | | | | | | | volume | capacity | |
| | | | | | | | | | | energy | retention | |
| Number | α | β | X | Y | A₂ | A₃ | M₂. | M₃ | C | density | rate | Note |
| Comparative | 1.13 | 10.0 | 24.5 | 14.6 | 5% | 5% | 400 | 660 | 3.6 | 340 | 98.3% | α = 1.13, β = 10, |
| Example 1 | | | | | | | | | | | | cell E.D. low |
| Comparative | 1.00 | 6.0 | 23 | 10 | 0% | 0.50% | 500 | 750 | 2.96 | 456 | 90.0% | α = 1, β = 6, |
| Example 2 | | | | | | | | | | | | cell E.D. very |
| | | | | | | | | | | | | high, short |
| | | | | | | | | | | | | service life |
| Embodiment | 1.10 | 8.21 | 24.6 | 13.2 | 0.50% | 4% | 420 | 700 | 3.5 | 400 | 97.5% | 1 ≤ α ≤ 1.13, |
| 1 | | | | | | | | | | | | 6 < β < 10, |
| | | | | | | | | | | | | cell E.D. high, |
| | | | | | | | | | | | | good service |
| | | | | | | | | | | | | life |
| Embodiment | 1.09 | 7.86 | 24.9 | 12.9 | 0.80% | 3.20% | 450 | 680 | 3.4 | 407 | 96.2% | 1 ≤ α ≤ 1.13, |
| 2 | | | | | | | | | | | | 6 < β < 10, |
| | | | | | | | | | | | | cell E.D. high, |
| | | | | | | | | | | | | good service |
| | | | | | | | | | | | | life |
| Embodiment | 1.06 | 8.12 | 24.9 | 12.6 | 0.50% | 3.50% | 430 | 680 | 3.52 | 420 | 95.0% | 1 ≤ α ≤ 1.13, |
| 3 | | | | | | | | | | | | 6 < β < 10, |
| | | | | | | | | | | | | cell E.D. high, |
| | | | | | | | | | | | | good service |
| | | | | | | | | | | | | life |
| Embodiment | 1.08 | 7.68 | 25.2 | 12.4 | 1% | 1.50% | 420 | 680 | 3.5 | 410 | 94.3% | 1 ≤ α ≤ 1.13, |
| 4 | | | | | | | | | | | | 6 < β < 10, |
| | | | | | | | | | | | | cell E.D. high, |
| | | | | | | | | | | | | good service |
| | | | | | | | | | | | | life |
| Embodiment | 1.05 | 7.29 | 26 | 12.2 | 0.50% | 1% | 450 | 700 | 3.45 | 430 | 92.5% | 1 ≤ α ≤ 1.13, |
| 5 | | | | | | | | | | | | 6 < β < 10, |
| | | | | | | | | | | | | cell E.D. high, |
| | | | | | | | | | | | | good service |
| | | | | | | | | | | | | life |

As could be seen from Table 1, the embodiments of the present disclosure achieved the simultaneous enhancement of the energy density and the cycle performance by controlling the performance parameters to at 1.0≤α≤1.13 and 6<β<10. Exceeding the above range will result in an unsatisfactory energy density or a poor service life.

Provided herein are merely some preferred embodiments of the disclosure, and are not intended to limit the present disclosure. For those skilled in the art, the present disclosure could have various modifications and variations. Any modifications, replacements and improvements made by those skilled in the art without departing from the spirit and principle of the disclosure shall fall within the scope of the disclosure defined by the appended claims.

### INDUSTRIAL APPLICABILITY

The present disclosure provides a positive electrode active material, including a lithium iron phosphate (LFP) positive electrode material, Li₂NiO₂ and Li₅FeO₄. By adjusting a mixing ratio and limiting the mixing ratio, a specific capacity of active materials and an electrolyte filling coefficient to satisfy a specific relationship, the specific capacity and cycle performance of LFP batteries can be significantly improved, thereby providing a theoretical reference during the LFP battery manufacturing process. The present disclosure is easily implementable, and have a superior industrial applicability.

What is claimed is:

1. A secondary battery, comprising:
a positive electrode plate;
wherein the positive electrode plate comprises a positive electrode active material and a positive electrode current collector; the positive electrode active material comprises a lithium iron phosphate (LFP) positive electrode material, a first lithium supplementing additive and a second lithium supplementing additive;
the secondary battery has a performance parameter β satisfying the following formula:
$$β = \frac{( {A}_{2} + {A}_{3} ) * 30 * 1000}{{M}_{2} + {M}_{3}} + 2 C ;$$
wherein the performance parameter β satisfies 6<β<10;
A₂ represents a weight percentage of the first lithium supplementing additive in the positive electrode active material;
A₃ represents a weight percentage of the second lithium supplementing additive in the positive electrode active material;
A₁, A₂ and A₃ satisfy the following conditions:
A₁+A₂+A₃=1, 80%≤A₁≤99%, 0<A₂≤15%, and 0<A₃≤15%; A₁ represents a weight percentage of the LFP positive electrode material in the positive electrode active material;
M₂ represents an initial charge specific capacity of the first lithium supplementing additive, expressed in a unit of mAh/g; and M₂ is 400-500 mAh/g;
M₃ represents an initial charge specific capacity of the second lithium supplementing additive, expressed in a unit of mAh/g; and M₃ is 650-750 mAh/g; and
C represents an electrolyte filling coefficient, expressed in a unit of g/Ah; and C satisfies C≤3.6 g/Ah.

2. The secondary battery according to claim 1, wherein the secondary battery further comprises a negative electrode plate; the negative electrode plate comprises a negative electrode active material and a negative electrode current collector;
the secondary battery further has a performance parameter α satisfying the following formula:
$$α = \frac{{M}_{4} * Y}{( {M}_{1} * {A}_{1} + {M}_{2} * {A}_{2} + {M}_{3} * {A}_{3} ) * X} ;$$
wherein the performance parameter α satisfies 1.0≤a≤1.13;
M₁ represents an initial charge specific capacity of the LFP positive electrode material, expressed in a unit of mAh/g; and M₁ is 150-170 mAh/g;
M₄ represents an initial charge specific capacity of the negative electrode active material, expressed in a unit of mAh/g; and M₄ is 350-400 mAh/g;
X represents a coating amount of the positive electrode active material on the positive electrode current collector, expressed in a unit of mg/cm²; and X is 17-32 mg/cm²;
Y represents a coating amount of the negative electrode active material on the negative electrode current collector, expressed in a unit of mg/cm²; and Y is 5-20 mg/cm²;
the negative electrode active material is graphite;
in response to a case that a discharge voltage range of the secondary battery is 2.0-4.4 V, M₁, M₂, M₃ and M₄ are determined, respectively; and
88%≤A₁≤99%, 0<A₂≤10%, and 0<A₃≤10%.

3. The secondary battery according to claim 1, wherein a material coated on the positive electrode current collector in the preparation of the positive electrode plate is a total positive electrode composite; a weight percentage of the positive electrode active material in the total positive electrode composite is 92-99%; and other components of the total positive electrode composite are a conductive agent, a binder and a dispersant, respectively.

4. The secondary battery according to claim 2, wherein a material coated on the negative electrode current collector in the preparation of the negative electrode plate is a total negative electrode composite; a weight percentage of the negative electrode active material in the total negative electrode composite is 85-99%; and other components of the total negative electrode composite are a conductive agent, a binder and a dispersant, respectively.

5. The secondary battery according to claim 4, wherein the negative electrode current collector is selected from the group consisting of copper foil, composite copper foil and a combination thereof; and a thickness of the negative electrode current collector is 1-20 μm.

6. The secondary battery according to claim 1, wherein the secondary battery further comprises a separator; the separator comprises a substrate and a coating attached to the substrate; a thickness of the substrate is 5-20 μm; and a thickness of the coating is 1-6 μm.

7. The secondary battery according to claim 6, wherein the substrate is made of polypropylene (PP), polyethylene (PE) or a combination thereof; and the coating is made of a ceramic material.

8. The secondary battery according to claim 1, wherein the LFP positive electrode material is doped with an element selected from the group consisting of Ti, Al, Mg, V, Ni, Mn and a combination thereof; and a content of the element doped in the LFP positive electrode material is less than 5,000 ppm.

9. The secondary battery according to claim 1, wherein the first lithium supplementing additive comprises Li₂NiO₂.

10. The secondary battery according to claim 9, wherein the first lithium supplementing additive is doped with an element selected from the group consisting of Ti, Al, Co, Mn and a combination thereof.

11. The secondary battery according to claim 10, wherein a content of the element doped in the first lithium supplementing additive is less than 5,000 ppm.

12. The secondary battery according to claim 1, wherein the second lithium supplementing additive comprises Li₅FeO₄.

13. The secondary battery according to claim 12, wherein the second lithium supplementing additive is doped with an element selected from the group consisting of Mn, Cu, Mo, Al, Ti, Mg, Zr, Zn and a combination thereof.

14. The secondary battery according to claim 13, wherein a content of the element doped in the second lithium supplementing additive is less than 5,000 ppm.

15. The secondary battery according to claim 13, wherein a surface of the second lithium supplementing additive is coated with a carbon layer; and a weight percentage of the carbon layer in the second lithium supplementing additive is 0.2-5.0%.

16. A positive electrode plate of a secondary battery, comprising:
a positive electrode active material; and
a positive electrode current collector;
wherein the positive electrode active material comprises a lithium iron phosphate (LFP) positive electrode material, a first lithium supplementing additive and a second lithium supplementing additive;
the secondary battery has a performance parameter β satisfying the following formula:
$$β = \frac{( {A}_{2} + {A}_{3} ) * 30 * 1000}{{M}_{2} + {M}_{3}} + 2 C ;$$
wherein the performance parameter β satisfies 6<<10;
A₂ represents a weight percentage of the first lithium supplementing additive in the positive electrode active material;
A₃ represents a weight percentage of the second lithium supplementing additive in the positive electrode active material;
A₁, A₂ and A₃ satisfy the following conditions:
A₁+A₂+A₃=1, 80%≤A₁≤99%, 0<A₂≤15%, and 0<A₃≤15%; A₁ represents a weight percentage of the LFP positive electrode material in the positive electrode active material;
M₂ represents an initial charge specific capacity of the first lithium supplementing additive, expressed in a unit of mAh/g; and M₂ is 400-500 mAh/g;
M₃ represents an initial charge specific capacity of the second lithium supplementing additive, expressed in a unit of mAh/g; and M₃ is 650-750 mAh/g; and
C represents an electrolyte filling coefficient, expressed in a unit of g/Ah; and C satisfies C≤3.6 g/Ah.

17. The positive electrode plate according to claim 16, wherein the first lithium supplementing additive comprises Li₂NiO₂; the first lithium supplementing additive is doped with an element selected from the group consisting of Ti, Al, Co, Mn and a combination thereof; and a content of the element doped in the first lithium supplementing additive is less than 5,000 ppm.

18. The positive electrode plate according to claim 16, wherein the second lithium supplementing additive comprises Li₅FeO₄; the second lithium supplementing additive is doped with an element selected from the group consisting of Mn, Cu, Mo, Al, Ti, Mg, Zr, Zn and a combination thereof; and a content of the element doped in the second lithium supplementing additive is less than 5,000 ppm.

19. An electrically-powered device, comprising:
the secondary battery according to claim 1.
